(19) United States
(12) Patent Application Publication
(10) Pub. No.: US 2017/0069294 A1
(43) Pub. Date: Mar. 9, 2017

(54) DRIVING DEVICE FOR DISPLAY PANEL, AND DISPLAY PANEL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: RENWEI GUO, Beijing (CN); XUE DONG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/101,171

(22) PCT Filed: Dec. 11, 2015
(86) PCT No.: PCT/CN2015/097097

§ 371 Date: Jun. 2, 2016

(30) Foreign Application Priority Data
Apr. 1, 2015 (CN) 201510151829.6

(51) Int. Cl. G09G 5/10; G09G 3/20

(52) U.S. Cl. CPC G09G 5/10; G09G 3/2092; G09G 2320/0646; G09G 2310/0237

(57) ABSTRACT

A driving device for a display panel and a display panel relate to the technical field of display. Virtualization algorithm and backlight adjustment algorithm are integrated in the driving integrated unit (12), so that a single processing system can realize both a virtual display function and a backlight adjustment function. On the one hand, capability for processing image information can be effectively improved, and on the other hand, additional wirings produced by an addition of the virtualization algorithm or backlight adjustment algorithm or the like can be avoided.

### TECHNICAL FIELD

The present disclosure relates to the technical field of display, and particularly to a driving device for a display panel, and a display panel.

### BACKGROUND

Application of virtual display technique is currently widespread in the technical field of display. In the virtual display technique, mainly through pixel sharing, each virtual pixel borrows a corresponding sub-pixel of a virtual pixel in an adjacent row to display a color it lacks itself, to achieve the same display function as achieved by each original pixel, thereby improving image resolution of a frame to be displayed. Backlight adjustment technique refers to first detecting brightness information of an image of a frame to be displayed, thereafter calculating an adjusted backlight brightness value of a backlight module according to the brightness information, then adjusting the backlight module according to the backlight brightness value, meanwhile performing adaption between the backlight brightness value and the image information to determine image grayscale brightness information that matches to the backlight brightness, and in turn transmitting the determined image grayscale brightness information to a panel for displaying.

However, in the conventional driving integrated unit, such as a driving integrated chip, the virtual display technique and the backlight adjustment technique are set independent of each other, virtual display and backlight adjustment cannot be implemented in a same driving device well.

### SUMMARY

In embodiments of the present disclosure, there are provided a driving device for a display panel, and a display panel, for solving the problem in the prior art that virtual display and backlight adjustment cannot be implemented in a same driving device well.

According to an embodiment of the present disclosure, there is provided a driving device for a display panel, comprising: an input interface unit configured to receive original image information of a frame to be displayed; a driving integrated unit configured to implement brightness adjustment on a backlight module according to the original image information received by the input interface unit, and implement virtual rendering on the received original image information received for a current frame in conjunction with a virtualization algorithm; and an output interface module configured to output an adjusted backlight brightness value to the backlight module, and output virtual-rendered image information to the display panel.

Preferably, the driving integrated unit comprises: a virtualization algorithm module connected with the input interface unit, and configured to perform virtual-rendering processing on the received original image information to obtain virtual image information; a brightness adjustment module connected with the virtualization algorithm module, and configured to receive the virtual image information, and calculate an adjusted backlight brightness value of the backlight module according to image brightness information detected from the virtual image information; and an information adaption module connected with the brightness adjustment module and the virtualization algorithm module, and configured to receive the virtual image information and concurrently receive the adjusted backlight brightness value calculated by the brightness adjustment module, perform adaption computing between the virtual image information and the adjusted background brightness value to obtain image grayscale brightness information, and output the virtual image information carrying the image grayscale brightness information to the output interface unit.

Preferably, the driving integrated unit comprises: a brightness adjustment module connected with the input interface unit, and configured to receive the original image information, and calculate an adjusted backlight brightness value of the backlight module according to image brightness information detected from the original image information; an information adaption module connected with the brightness adjustment module and the input interface unit, and configured to receive the original image information and concurrently receive the adjusted backlight brightness value calculated by the brightness adjustment module, perform adaption computing between the original image information and the adjusted background brightness value to obtain image grayscale brightness information; and a virtualization algorithm module connected with the information adaption module, and configured to receive the original image information carrying the image grayscale brightness information, perform virtual-rendering processing on the original image information to obtain virtual image information, and output the virtual image information carrying the image grayscale brightness information to the output interface unit.

Preferably, the driving integrated unit is further configured to: perform signal conversion on the received original image information or processed virtual image information.

Preferably, the driving integrated unit comprises: a signal conversion module connected with the input interface unit, and configured to convert the received original image information in the form of an RGB signal to image information in the form of an RGBW signal; a virtualization algorithm module connected with the signal conversion module, and configured to perform virtual rendering processing on the received image information in the form of the RGBW signal, to obtain virtual image information in the form of the RGBW signal; a brightness adjustment module connected with the virtualization algorithm module, and configured to receive the virtual image information in the form of the RGBW signal, and calculate an adjusted backlight brightness value of the backlight module according to image brightness information detected from the virtual image information in the form of the RGBW signal; and an information adaption module connected with the brightness adjustment module and the virtualization algorithm module, and configured to receive the virtual image information in the form of the RGBW signal and concurrently receive the adjusted backlight brightness value calculated by the brightness adjustment module, perform adaption computing between the virtual image information in the form of the RGBW signal and the adjusted background brightness value to obtain image grayscale brightness information, and output the virtual image information in the form of the RGBW signal and carrying the image grayscale brightness information to the output interface unit.

Preferably, the driving integrated unit comprises: a signal conversion module connected with the input interface unit, and configured to convert the received original image information in the form of an RGB signal to image information in the form of an RGBW signal; a brightness adjustment module connected with the signal conversion module, and configured to receive the image information in the form of the RGBW signal, and calculate an adjusted backlight brightness value of the backlight module according to image brightness information detected from the image information in the form of the RGBW signal; an information adaption module connected with the brightness adjustment module and the signal conversion module, and configured to receive the image information in the form of the RGBW signal and concurrently receive the adjusted backlight brightness value calculated by the brightness adjustment module, perform adaption computing between the image information in the form of the RGBW signal and the adjusted background brightness value to obtain image grayscale brightness information; and a virtualization algorithm module connected with the information adaption module, and configured to receive the image information in the form of the RGBW signal and carrying the image grayscale brightness information, perform virtual-rendering processing on the image information in the form of the RGBW signal to obtain virtual image information in the form of the RGBW signal and carrying the image grayscale brightness information.

Preferably, the driving integrated unit comprises: a virtualization algorithm module connected with the input interface unit, and configured to perform virtual rendering processing on the received original image information in the form of a RGB signal, to obtain virtual image information in the form of the RGB signal; a brightness adjustment module connected with the virtualization algorithm module, and configured to receive the virtual image information in the form of the RGB signal, and calculate an adjusted backlight brightness value of the backlight module according to image brightness information detected from the virtual image information in the form of the RGB signal; an information adaption module connected with the brightness adjustment module and the virtualization algorithm module, and configured to receive the virtual image information in the form of the RGB signal and concurrently receive the adjusted backlight brightness value calculated by the brightness adjustment module, perform adaption computing between the virtual image information in the form of the RGB signal and the adjusted background brightness value to obtain image grayscale brightness information; and a signal conversion module connected with the input interface unit, and configured to convert the received virtual image information in the form of the RGB signal and carrying the image grayscale brightness information to virtual image information in the form of an RGBW signal and carrying the image grayscale brightness information.

Preferably, the integrated driving unit comprising: a brightness adjustment module connected with the input interface unit, and configured to receive the original image information in the form of an RGB signal, and calculate an adjusted backlight brightness value of the backlight module according to image brightness information detected from the original image information in the form of the RGB signal; an information adaption module connected with the brightness adjustment module and the input interface unit, and configured to receive the original image information in the form of the RGB signal and concurrently receive the adjusted backlight brightness value calculated by the brightness adjustment module, perform adaption computing between the original image information in the form of the RGB signal and the adjusted background brightness value to obtain image grayscale brightness information; a signal conversion module connected with the information adaption module, and configured to convert the received original image information in the form of the RGB signal and carrying the image grayscale brightness information to image information in the form of the RGBW signal and carrying the image grayscale brightness information; and a virtualization algorithm module connected with the signal conversion module, and configured to receive the image information in the form of the RGBW signal and carrying the image grayscale brightness information, perform virtual-rendering processing on the image information in the form of the RGBW signal to obtain virtual image information in the form of the RGBW signal and carrying the image grayscale brightness information.

According to an embodiment of the present disclosure, there is provided a display panel comprising the driving device described above.

In the embodiments of the present disclosure, relying on a driving chip or other software modules in the driving integrated unit, virtualization algorithm and backlight adjustment algorithm are integrated in the driving integrated unit, thereby algorithms that would be separately integrated in two independent processing systems are integrated in a singe driving integrated unit, so that a single processing system can realize both a virtual display function and a backlight adjustment function. On the one hand, capability for processing image information can be improved, and on the other hand, additional wirings produced by an addition of the virtualization algorithm or backlight adjustment, algorithm or the like can be avoided.

### BRIEF DESCRIPTION OF THE DRAWINGS

In order to more clearly illustrate the technical solutions in the embodiments of the present disclosure, drawings necessary for describing the embodiments will be briefly introduced below, obviously, the drawings in the following description merely are parts embodiments of the present disclosure, other drawings may also be attained by those of ordinary skill in the art based on these drawings without paying creative effort.

FIG. 1 is a schematic diagram of structure of a driving device for a display panel provided by an embodiment of the present disclosure;

FIG. 2 is a schematic diagram of structure of a driving integrated chip in a first embodiment of the present disclosure;

FIG. 3 is a schematic diagram of architecture of a brightness adjustment module provided by an embodiment of the present disclosure;

FIG. 4 is a schematic diagram of structure of a driving integrated chip in a second embodiment of the present disclosure;

FIG. 5 is a schematic diagram of structure of a driving integrated chip in a third embodiment of the present disclosure;

FIG. 6 is a schematic diagram of structure of a driving integrated chip in a fourth embodiment of the present disclosure;

FIG. 7 is a schematic diagram of structure of a driving integrated chip in a fifth embodiment of the present disclosure; and

FIG. 8 is a schematic diagram of structure of a driving integrated chip in a sixth embodiment of the present disclosure.

### DETAILED DESCRIPTION OF THE EMBODIMENTS

To make the objects, technical solutions, and advantages of the present disclosure more clear and obvious, hereinafter, the technical solutions in the embodiments of the present disclosure will be described clearly and comprehensively in combination with the drawings, obviously, these described embodiments are parts of the embodiments of the present disclosure, rather than all of the embodiments thereof, all the other embodiments obtained by those of ordinary skill in the art based on the embodiments of the present disclosure without paying creative efforts fall into the protection scope of the present disclosure.

In the embodiments of the present disclosure, relying on a driving chip or other software modules in the driving integrated unit, virtualization algorithm and backlight adjustment algorithm are integrated in the driving integrated unit, thereby algorithms that would be separately integrated in two independent processing systems are integrated in a singe driving integrated unit, so that a single processing system can realize both a virtual display function and a backlight adjustment function. On the one hand, capability for processing image information can be improved, and on the other hand, additional wirings produced by an addition of the virtualization algorithm or backlight adjustment, algorithm or the like can be avoided.

Hereinafter, the technical solutions to which the present disclosure relate will be detailed in detail through specific embodiments, the present disclosure includes but not limited to the embodiments provided as follows.

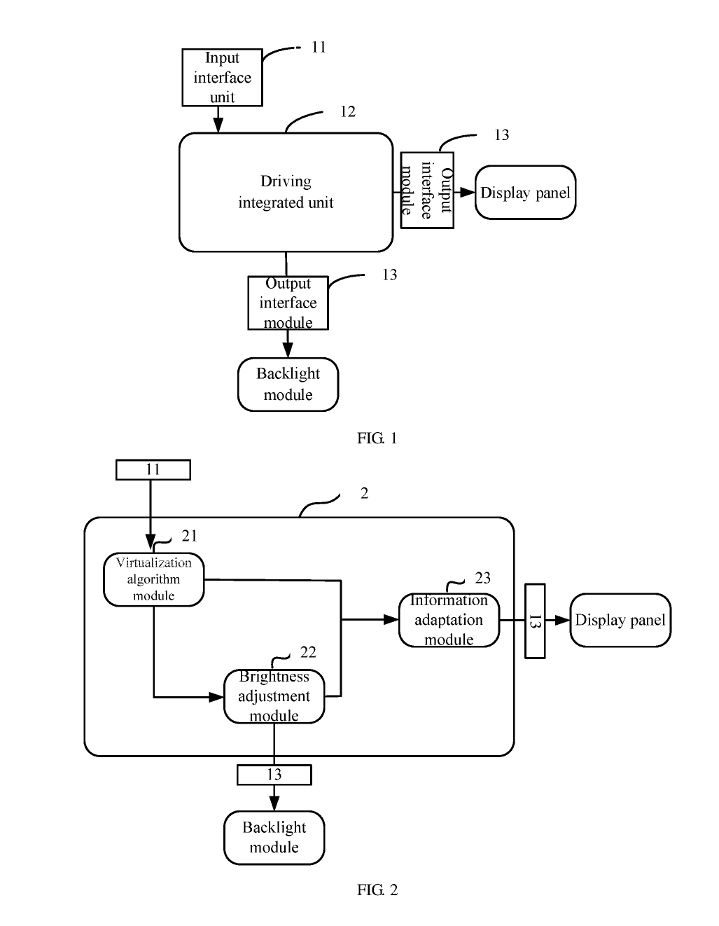

As shown in FIG. 1, FIG. 1 is a schematic diagram of structure of a driving device for a display panel provided by an embodiment of the present disclosure.

The driving device comprises an input interface unit 11, a driving integrated unit 12, and an output interface module 13.

The input interface unit 11 is configured to receive original image information of a frame to be displayed.

The driving integrated unit 12 is configured to implement brightness adjustment on a backlight module according to the original image information received by the input interface unit, and implement virtual rendering on the original image information received for a current frame in conjunction with a virtualization algorithm.

The output interface module 13 is configured to output an adjusted backlight brightness value to the backlight module, and output the virtual-rendered image information to the display panel.

The driving integrated unit 12 may be an integrated chip for driving the display panel to display, and various circuits, algorithms and so on may be integrated thereon. The driving integrated unit 12 may also be a software module. The present disclose makes no limitations thereto. Preferably, all of the following descriptions are provided with a driving integrated chip as an example.

In the embodiments of the present disclosure, the virtualization algorithm and the backlight adjustment algorithm are integrated in the driving integrated chip, so that a single processing system can realize both the virtual display function and the backlight adjustment function. Capability for processing image information can be improved, meanwhile additional wirings produced by an addition of the virtualization algorithm or backlight adjustment algorithm or the like can be avoided.

Concrete structure of the driving integrated chip will be described below through specific embodiments.

### First Embodiment

As shown in FIG. 2, FIG. 2 is a schematic diagram of structure of a driving integrated chip in a first embodiment of the present disclosure, the driving integrated chip 2 specifically comprises a virtualization algorithm module 21, a brightness adjustment module 22, and an information adaptation module 23.

The virtualization algorithm module 21 is connected with the input interface unit 11, and configured to perform virtual-rendering processing on the received original image information to obtain virtual image information. The original image information typically is three-color image information in the form of a RGB signal.

The brightness adjustment module 22 is connected with the virtualization algorithm module 21 and configured to receive the virtual image information, and calculate an adjusted backlight brightness value of the backlight module according to image brightness information detected from the virtual image information. On the other hand, the brightness adjustment module 22 is connected with the output interface unit 13, which is configured to output the adjusted backlight brightness value of the backlight module thus calculated to the backlight module for backlight brightness displaying.

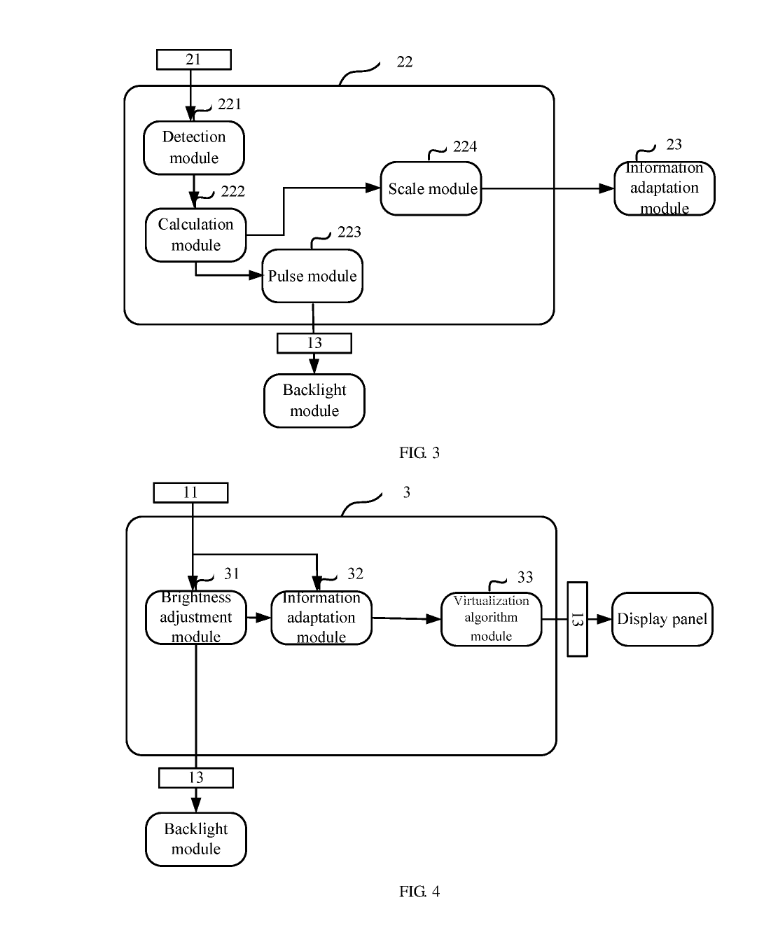

Specifically, the brightness adjustment module 22 may comprise a detection module 221, a calculation module 222 and a pulse module 223 as shown in FIG. 3. The detection module 221 is configured to detect image brightness information of the received virtual image information to obtain a corresponding brightness value. The calculation module 222 is configured to calculate an adjusted brightness value of the backlight module according to the brightness value detected by the detection module 221, and a specific calculating method of the calculation module 222 conforms to conventional calculation rules. The pulse module 223 adjusts brightness of the backlight module according to the adjusted brightness value of the backlight module calculated by the calculation module 222, and a specific adjustment scheme of the pulse module 223 is formulated and selected according to a display scheme in practice. In addition, the brightness adjustment module 22 may further comprise a scale module 224, which is configured to perform scaling processing on the adjusted backlight brightness value calculated by the calculation module 222, and a scaling rule of the scale module 224 is selected according to a display adjustment scheme in practice.

The information adaptation module 23 is connected with the brightness adjustment module 22 and the virtualization algorithm module 21, and configured to receive the virtual image information and concurrently receive the adjusted backlight brightness value of the backlight module calculated by the brightness adjustment module 22, perform adaption computing between the virtual image information and the adjusted background brightness value to obtain image grayscale brightness information, and output the virtual image information carrying the image grayscale brightness information to the display panel for displaying via the output interface unit 13.

In the solution supported by the structure of the driving integrated chip, first, virtual-rendering processing is performed on the received original image information in the form of the RGB signal to obtain the virtual image information in the form of the RGB signal; thereafter, brightness detection is performed on the virtual image information, and further the backlight brightness value is calculated according to a result of the brightness detection to implement adjustment on the backlight brightness; and further, adaption is performed between the virtual image information and the calculated backlight brightness value to obtain the image grayscale brightness information of the image of the current frame, and the virtual image information carrying the image grayscale brightness information is outputted to the display panel for image displaying. Integration of the virtualization algorithm and the backlight adjustment algorithm is implemented in a single driving integrated chip, and thus image information processing capability of the driving device is improved effectively.

### Second Embodiment

As shown in FIG. 4, FIG. 4 is a schematic diagram of structure of a driving integrated chip in a second embodiment of the present disclosure, the driving integrated chip 3 specifically comprises a brightness adjustment module 31, an information adaptation module 32, and a virtualization algorithm module 33.

The brightness adjustment module 31 is connected with the input interface unit 11, and configured to receive the original image information, and calculate an adjusted backlight brightness value of the backlight module according to image brightness information detected from the original image information.

Specifically, the brightness adjustment module 31 may comprise module units as shown in FIG. 3, different than the brightness adjustment module 22 shown in FIG. 2, image information processed by the brightness adjustment module 31 in the second embodiment is the original image information, whereas image information processed by the brightness adjustment module 22 in the first embodiment is the virtual image information.

The information adaptation module 32 is connected with the brightness adjustment module 31 and the input interface unit 11, and configured to receive the original image information and concurrently receive the adjusted backlight brightness value calculated by the brightness adjustment module 31, perform adaption computing between the original image information and the adjusted background brightness value to obtain image grayscale brightness information.

The virtualization algorithm module 33 is connected with the information adaptation module 32, and configured to receive the original image information carrying the image grayscale brightness information, perform virtual-rendering processing on the original image information to obtain virtual image information, and output the virtual image information carrying the image grayscale brightness information to the display panel for displaying via the output interface unit 13.

In the solution supported by the structure of the driving integrated chip in the second embodiment, first, brightness detection is performed on the received original image information in the form of a RGB signal and a backlight brightness value is calculated according to a result of the brightness detection, thereby backlight brightness adjustment is implemented; thereafter, adaption is performed between the original image information in the form of the RGB signal and the calculated backlight brightness value to obtain image grayscale brightness information of the image of the current frame, and virtual rendering processing is performed on the original image information in the form of the RGB signal and carrying the image grayscale brightness information to obtain virtual image information in the form of the RGB signal, and the virtual image information in the form of the RGB signal and carrying the image grayscale brightness information is outputted to the display panel for image display. Integration of the virtualization algorithm and the backlight adjustment algorithm is implemented in a single driving integrated chip, and thus image information processing capability of the driving device is improved effectively.

Preferably, in this embodiment of the present disclosure, the received original image information in the form of RGB signal may be processed directly, in addition, in order to further improve a color effect of display, it is also possible to convert the original image information in the form of the RGB signal to the form of a RGBW signal prior to processing the original image information in the form of the RGB signal.

### Third Embodiment

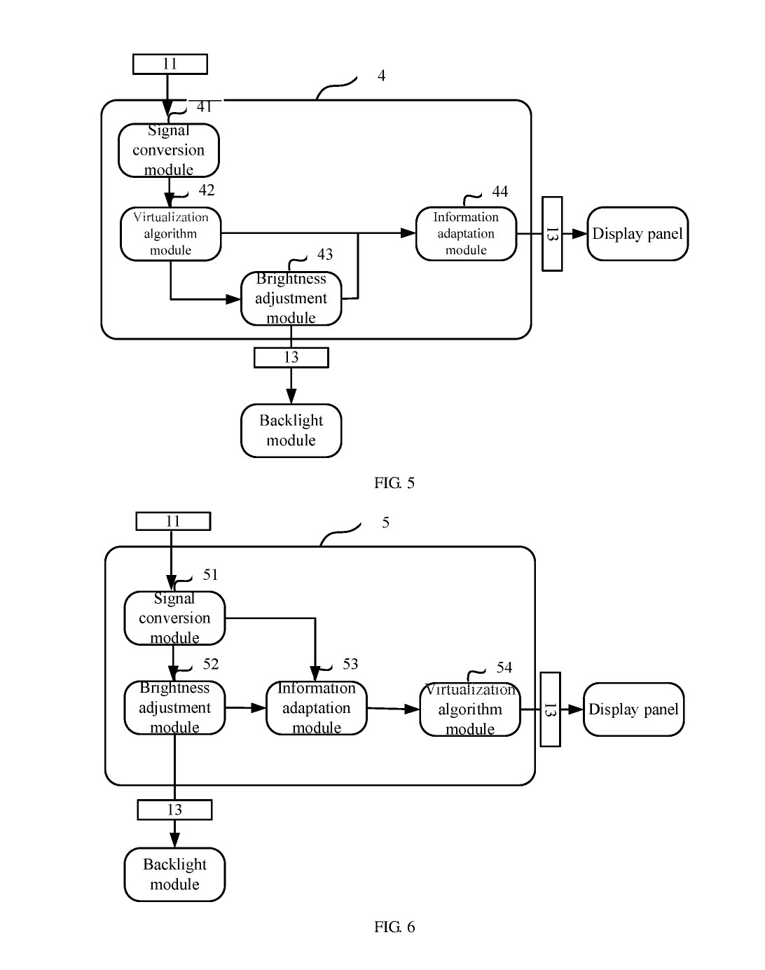

As shown in FIG. 5, FIG. 5 is a schematic diagram of structure of a driving integrated chip in a third embodiment of the present disclosure, the driving integrated chip 4 specifically comprises a signal conversion module 41, a virtualization algorithm module 42, a brightness adjustment module 43 and an information adaptation module 44.

The signal conversion module 41 is connected with the input interface unit 11, and configured to convert the received original image information in the form of an RGB signal to image information in the form of an RGBW signal.

The virtualization algorithm module 42 is connected with the signal conversion module 41, and configured to perform virtual rendering processing on the received image information in the form of the RGBW signal, to obtain virtual image information in the form of the RGBW signal.

The brightness adjustment module 43 is connected with the virtualization algorithm module 42, and configured to receive the virtual image information in the form of the RGBW signal, and calculate an adjusted backlight brightness value of the backlight module according to image brightness information detected from the virtual image information in the form of the RGBW signal.

The information adaptation module 44 is connected with the brightness adjustment module 43 and the virtualization algorithm module 42, and configured to receive the virtual image information in the form of the RGBW signal and concurrently receive the adjusted backlight brightness value calculated by the brightness adjustment module 43, perform adaption computing between the virtual image information in the form of the RGBW signal and the adjusted background brightness value to obtain image grayscale brightness information, and output the virtual image information in the form of the RGBW signal and carrying the image grayscale brightness information to the display panel for displaying via the output interface unit 13.

In the solution supported by the structure of the driving integrated chip in the third embodiment, first, the received original image information in the form of the RGB signal is converted into image information in the form the RGBW signal; virtual-rendering processing is performed on the image information in the form of the RGBW signal to obtain virtual image information in the form of the RGBW signal; thereafter, brightness detection is performed on the virtual image information in the form of the RGBW signal, and the backlight brightness value is then calculated according to a result of the brightness detection to implement adjustment on the backlight brightness; and further, adaption is performed between the virtual image information in the form of the RGBW signal and the calculated backlight brightness value to obtain image grayscale brightness information of the image of the current frame, and the virtual image information in the form of the RGBW signal and carrying the image grayscale brightness information is outputted to the display panel for image displaying. Integration of the virtualization algorithm and the backlight adjustment algorithm is implemented in a single driving integrated chip, and thus image information processing capability of the driving device is improved effectively.

### Fourth Embodiment

As shown in FIG. 6, FIG. 6 is a schematic diagram of structure of a driving integrated chip in a fourth embodiment of the present disclosure, the driving integrated chip 5 comprises a signal conversion module 51, a brightness adjustment module 52, an information adaptation module 53, and a virtual algorithm module 54.

The signal conversion module 51 is connected with the input interface unit 11, and configured to convert the received original image information in the form of an RGB signal to image information in the form of an RGBW signal.

The brightness adjustment module 52 is connected with the virtual algorithm module 51, and configured to receive the image information in the form of the RGBW signal, and calculate a current adjusted backlight brightness value of the backlight module according to image brightness information detected as contained in the image information in the form of the RGBW signal.

The information adaptation module 53 is connected with the brightness adjustment module 52 and the signal conversion module 51, and configured to receive the image information in the form of the RGBW signal and concurrently receive the adjusted backlight brightness value calculated by the brightness adjustment module 52, perform adaption computing between the image information in the form of the RGBW signal and the adjusted background brightness value to obtain image grayscale brightness information.

The virtual algorithm module 54 is connected with the information adaptation module 53, and configured to receive image information in the form of the RGBW signal and carrying the image grayscale brightness information, perform virtual-rendering processing on the image information in the form of the RGBW signal to obtain virtual image information in the form of the RGBW signal and carrying the image grayscale brightness information to the display panel for displaying via the output interface unit 13.

In the solution supported by the structure of the driving integrated chip in the fourth embodiment, first, the received original image information in the form of the RGB signal is converted into image information in the form the RGBW signal, brightness detection is performed on the image information in the form of the RGBW signal and then a backlight brightness value is calculated according to a result of the brightness detection to implement adjustment on the backlight brightness; thereafter, adaption is performed between the image information in the form of the RGBW signal to obtain image grayscale brightness information of the image of the current frame; and virtual rendering processing is performed on the image information in the form of the RGBW signal and carrying the image grayscale brightness information to obtain virtual image information in the form of the RGBW signal, and the virtual image information in the form of the RGBW signal is outputted to the display panel for image display. Integration of the virtualization algorithm and the backlight adjustment algorithm is implemented in a single driving integrated chip, and thus image information processing capability of the driving device is improved effectively.

### Fifth Embodiment

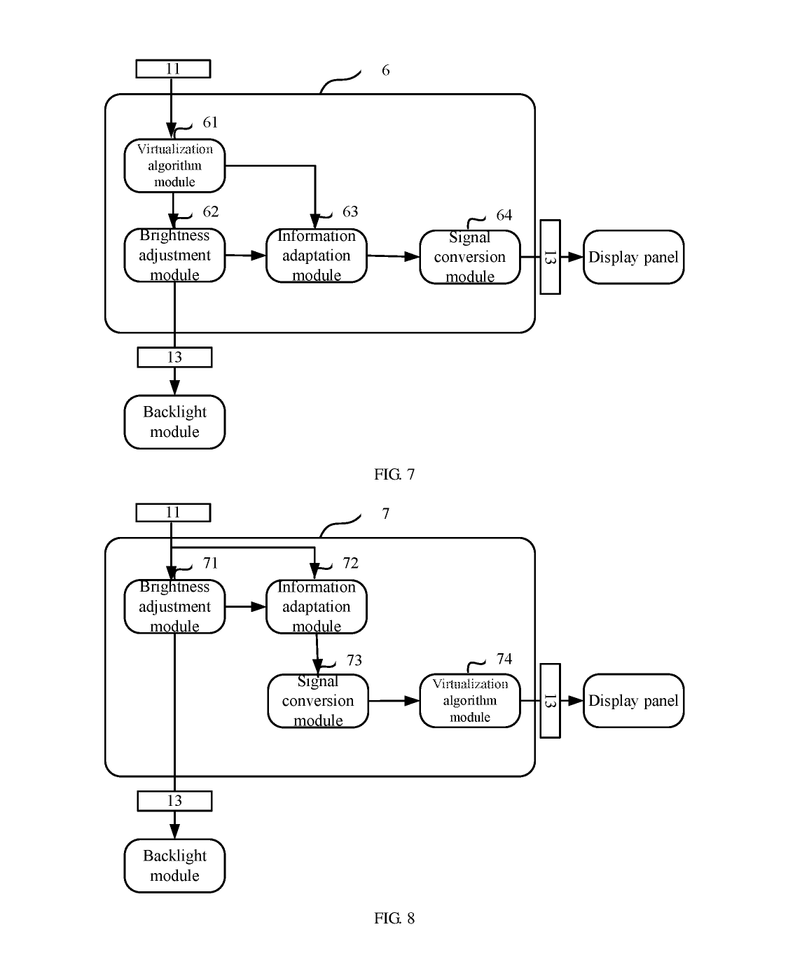

As shown in FIG. 7, FIG. 7 is a schematic diagram of structure of a driving integrated chip in a fifth embodiment of the present disclosure, the driving integrated chip 6 specifically comprises a virtualization algorithm module 61, a brightness adjustment module 62, an information adaption module 63 and a signal conversion module 64.

The virtualization algorithm module 61 is connected with the input interface unit 11, and configured to perform virtual rendering processing on the received original image information in the form of a RGB signal, to obtain virtual image information in the form of the RGB signal.

The brightness adjustment module 62 is connected with the virtualization algorithm module 61, and configured to receive the virtual image information in the form of the RGB signal, and calculate an adjusted backlight brightness value of the backlight module according to image brightness information detected from the virtual image information in the form of the RGB signal.

The information adaption module 63 is connected with the brightness adjustment module 62 and the virtualization algorithm module 61, and configured to receive the virtual image information in the form of the RGB signal and concurrently receive the adjusted backlight brightness value calculated by the brightness adjustment module 62, perform adaption computing between the virtual image information in the form of the RGB signal and the adjusted background brightness value to obtain image grayscale brightness information.

The signal conversion module 64 is connected with the information adaption module 63, and configured to convert the received virtual image information in the form of the RGB signal and carrying the image grayscale brightness information to virtual image information in the form of an RGBW signal and carrying the image grayscale brightness information to the display panel for displaying via the output interface unit 13.

In the solution supported by the structure of the driving integrated chip in the fifth embodiment, first, virtual-rendering processing is performed on the received original image information in the form of the RGB signal to obtain virtual image information in the form of the RGB signal; thereafter, brightness detection is performed on the virtual image information, and the backlight brightness value is then calculated according to a result of the brightness detection to implement adjustment on the backlight brightness; further, adaption is performed between the virtual image information in the form of the RGB and the calculated backlight brightness value to obtain image grayscale brightness information of the image of the current frame; and the virtual image information in the form of the RGB signal and carrying the image grayscale brightness information is converted into virtual image information in the form of the RGBW signal, and the virtual image information in the form of the RGBW signal and carrying the image grayscale brightness information is outputted to the display panel for image displaying. Integration of the virtualization algorithm and the backlight adjustment algorithm is implemented in a single driving integrated chip, and thus image information processing capability of the driving device is improved effectively.

### Sixth Embodiment

As shown in FIG. 8, FIG. 8 is a schematic diagram of structure of a driving integrated chip in a sixth embodiment of the present disclosure, the driving integrated chip 7 specifically comprises a brightness adjustment module 71, an information adaption module 72, a signal conversion module 73, and a virtualization algorithm module 74.

The brightness adjustment module 71 is connected with the input interface unit 11, and configured to receive the original image information in the form of an RGB signal, and calculate an adjusted backlight brightness value of the backlight module according to image brightness information detected from the original image information in the form of the RGB signal.

The information adaption module 72 is connected with the brightness adjustment module 71 and the input interface unit 11, and configured to receive the original image information in the form of the RGB signal and concurrently receive the adjusted backlight brightness value calculated by the brightness adjustment module 71, perform adaption computing between the original image information in the form of the RGB signal and the adjusted background brightness value to obtain image grayscale brightness information.

The signal conversion module 73 is connected with the information adaption module 72, and configured to convert the received original image information in the form of the RGB signal and carrying the image grayscale brightness information to image information in the form of the RGBW signal and carrying the image grayscale brightness information.

The virtualization algorithm module 74 is connected with the signal conversion module 73, and configured to receive the image information in the form of the RGBW signal and carrying the image grayscale brightness information, perform virtual-rendering processing on the image information in the form of the RGBW signal to obtain virtual image information in the form of the RGBW signal and carrying the image grayscale brightness information, and the virtual image information in the form of the RGBW signal and carrying the image grayscale brightness information is outputted to the display panel for displaying via the output interface unit 13.

In the solution supported by the structure of the driving integrated chip in the sixth embodiment, first, brightness detection is performed on the received original image information in the form of a RGB signal and then a backlight brightness value is calculated according to a result of the brightness detection to implement adjustment on backlight brightness; thereafter, adaption is performed between the original image information in the form of the RGB signal and the calculated backlight brightness value to obtain grayscale brightness information of the image of the current frame; then the original image information in the form of RGB signal and carrying the image grayscale brightness information is converted into image information in the form of the RGBW signal, and virtual rendering processing is performed on the image information in the form of the RGBW to obtain virtual image information in the form of the RGBW signal, and the virtual image information in the form of the RGBW signal is outputted to the display panel for image display. Integration of the virtualization algorithm and the backlight adjustment algorithm is implemented in a single driving integrated chip, and thus image information processing capability of the driving device is improved effectively.

Meanwhile, according to an embodiment of the present disclosure, there is further provided a display panel, comprising the driving device in various structures as described above.

Although the preferred embodiments of the present disclosure have been described, those skilled in the art can make additional changes and modifications to these embodiments once learning the basic inventive concepts thereof. Therefore, the appended claims are intended to be interpreted as including the preferred embodiments as well as all changes and modifications that fall into the scope of the present disclosure.

Obviously, those skilled in the art can make various modifications and variations to the present disclosure without departing from the spirit and scope thereof. Thus, if these modifications and variations of the present disclosure are within the scope of the claims of the disclosure as well as their equivalents, the present disclosure is also intended to include these modifications and variations.

The present application claims priority of the Chinese Patent Application No. 201510151829.6 and entitled “DRIVING DEVICE FOR DISPLAY PANEL, AND DISPLAY PANEL” filed on Apr. 1, 2015, the entire disclosure of which is hereby incorporated in full text by reference as part of the present application.

1. A driving device for a display panel, comprising:
an input interface unit configured to receive original image information of a frame to be displayed;
a driving integrated unit configured to implement brightness adjustment on a backlight module according to the original image information received by the input interface unit, and implement virtual rendering on the received original image information of the frame to be displayed in conjunction with a virtualization algorithm; and
an output interface module configured to output an adjusted backlight brightness value to the backlight module, and output virtual-rendered image information to the display panel.

2. The driving device according to claim 1, wherein the driving integrated unit comprises:
a virtualization algorithm module connected with the input interface unit, and configured to perform virtual-rendering processing on the received original image information to obtain virtual image information;
a brightness adjustment module connected with the virtualization algorithm module, and configured to receive the virtual image information, and calculate an adjusted backlight brightness value of the backlight module according to image brightness information detected from the virtual image information; and
an information adaption module connected with the brightness adjustment module and the virtualization algorithm module, and configured to receive the virtual image information and concurrently receive the adjusted backlight brightness value calculated by the brightness adjustment module, perform adaption computing between the virtual image information and the adjusted background brightness value to obtain image grayscale brightness information, and output the virtual image information carrying the image grayscale brightness information to the output interface unit.

3. The driving device according to claim 1, wherein the driving integrated unit comprises:
a brightness adjustment module connected with the input interface unit, and configured to receive the original image information, and calculate an adjusted backlight brightness value of the backlight module according to image brightness information detected from the original image information;
an information adaption module connected with the brightness adjustment module and the input interface unit, and configured to receive the original image information and concurrently receive the adjusted backlight brightness value calculated by the brightness adjustment module, perform adaption computing between the original image information and the adjusted background brightness value to obtain image grayscale brightness information; and
a virtualization algorithm module connected with the information adaption module, and configured to receive the original image information carrying the image grayscale brightness information, perform virtual-rendering processing on the original image information to obtain virtual image information, and output the virtual image information carrying the image grayscale brightness information to the output interface unit.

4. The driving device according to claim 1, wherein the driving integrated unit is further configured to:
perform signal conversion on the received original image information or virtual image information obtained after performing virtual-rendering processing on the original image information.

5. The driving device according to claim 4, wherein the driving integrated unit comprises:
a signal conversion module connected with the input interface unit, and configured to convert the received original image information in the form of an RGB signal to image information in the form of an RGBW signal;
a virtualization algorithm module connected with the signal conversion module, and configured to perform virtual rendering processing on the received image information in the form of the RGBW signal, to obtain virtual image information in the form of the RGBW signal;
a brightness adjustment module connected with the virtualization algorithm module, and configured to receive the virtual image information in the form of the RGBW signal, and calculate an adjusted backlight brightness value of the backlight module according to image brightness information detected from the virtual image information in the form of the RGBW signal; and
an information adaption module connected with the brightness adjustment module and the virtualization algorithm module, and configured to receive the virtual image information in the form of the RGBW signal and concurrently receive the adjusted backlight brightness value calculated by the brightness adjustment module, perform adaption computing between the virtual image information in the form of the RGBW signal and the adjusted background brightness value to obtain image grayscale brightness information, and output the virtual image information in the form of the RGBW signal and carrying the image grayscale brightness information to the output interface unit.

6. The driving device according to claim 4, wherein the driving integrated unit comprises:
a signal conversion module connected with the input interface unit, and configured to convert the received original image information in the form of an RGB signal to image information in the form of an RGBW signal;
a brightness adjustment module connected with the signal conversion module, and configured to receive the image information in the form of the RGBW signal, and calculate an adjusted backlight brightness value of the backlight module according to image brightness information detected from the image information in the form of the RGBW signal;
an information adaption module connected with the brightness adjustment module and the signal conversion module, and configured to receive the image information in the form of the RGBW signal and concurrently receive the adjusted backlight brightness value calculated by the brightness adjustment module, perform adaption computing between the image information in the form of the RGBW signal and the adjusted background brightness value to obtain image grayscale brightness information; and
a virtualization algorithm module connected with the information adaption module, and configured to receive the image information in the form of the RGBW signal and carrying the image grayscale brightness information, perform virtual-rendering processing on the image information in the form of the RGBW signal to obtain virtual image information in the form of the RGBW signal and carrying the image grayscale brightness information.

7. The driving device according to claim 4, wherein the driving integrated unit comprises:
a virtualization algorithm module connected with the input interface unit, and configured to perform virtual rendering processing on the received original image information in the form of a RGB signal, to obtain virtual image information in the form of the RGB signal;
a brightness adjustment module connected with the virtualization algorithm module, and configured to receive the virtual image information in the form of the RGB signal, and calculate an adjusted backlight brightness value of the backlight module according to image brightness information detected from the virtual image information in the form of the RGB signal;
an information adaption module connected with the brightness adjustment module and the virtualization algorithm module, and configured to receive the virtual image information in the form of the RGB signal and concurrently receive the adjusted backlight brightness value calculated by the brightness adjustment module, perform adaption computing between the virtual image information in the form of the RGB signal and the adjusted background brightness value to obtain image grayscale brightness information; and
a signal conversion module connected with the information adaption module, and configured to convert the received virtual image information in the form of the RGB signal and carrying the image grayscale brightness information to virtual image information in the form of an RGBW signal and carrying the image grayscale brightness information.

8. The driving device according to claim 4, wherein the driving integrated unit comprises:
a brightness adjustment module connected with the input interface unit, and configured to receive the original image information in the form of an RGB signal, and calculate an adjusted backlight brightness value of the backlight module according to image brightness information detected from the original image information in the form of the RGB signal;
an information adaption module connected with the brightness adjustment module and the input interface unit, and configured to receive the original image information in the form of the RGB signal and concurrently receive the adjusted backlight brightness value calculated by the brightness adjustment module, perform adaption computing between the original image information in the form of the RGB signal and the adjusted background brightness value to obtain image grayscale brightness information;
a signal conversion module connected with the information adaption module, and configured to convert the received original image information in the form of the RGB signal and carrying the image grayscale brightness information to image information in the form of the RGBW signal and carrying the image grayscale brightness information; and
a virtualization algorithm module connected with the signal conversion module, and configured to receive the image information in the form of the RGBW signal and carrying the image grayscale brightness information, perform virtual-rendering processing on the image information in the form of the RGBW signal to obtain virtual image information in the form of the RGBW signal and carrying the image grayscale brightness information.

9. A display panel comprising the driving device according to claim 1.

10. The display panel according to claim 9, wherein the driving integrated unit comprises:
a virtualization algorithm module connected with the input interface unit, and configured to perform virtual-rendering processing on the received original image information to obtain virtual image information;
a brightness adjustment module connected with the virtualization algorithm module, and configured to receive the virtual image information, and calculate an adjusted backlight brightness value of the backlight module according to image brightness information detected from the virtual image information; and
an information adaption module connected with the brightness adjustment module and the virtualization algorithm module, and configured to receive the virtual image information and concurrently receive the adjusted backlight brightness value calculated by the brightness adjustment module, perform adaption computing between the virtual image information and the adjusted background brightness value to obtain image grayscale brightness information, and output the virtual image information carrying the image grayscale brightness information to the output interface unit.

11. The display panel according to claim 9, wherein the driving integrated unit comprises:
a brightness adjustment module connected with the input interface unit, and configured to receive the original image information, and calculate an adjusted backlight brightness value of the backlight module according to image brightness information detected from the original image information;
an information adaption module connected with the brightness adjustment module and the input interface unit, and configured to receive the original image information and concurrently receive the adjusted backlight brightness value calculated by the brightness adjustment module, perform adaption computing between the original image information and the adjusted background brightness value to obtain image grayscale brightness information; and
a virtualization algorithm module connected with the information adaption module, and configured to receive the original image information carrying the image grayscale brightness information, perform virtual-rendering processing on the original image information to obtain virtual image information, and output the virtual image information carrying the image grayscale brightness information to the output interface unit.

12. The display panel according to claim 9, wherein the driving integrated unit comprises:
a signal conversion module connected with the input interface unit, and configured to convert the received original image information in the form of an RGB signal to image information in the form of an RGBW signal;
a virtualization algorithm module connected with the signal conversion module, and configured to perform virtual rendering processing on the received image information in the form of the RGBW signal, to obtain virtual image information in the form of the RGBW signal;
a brightness adjustment module connected with the virtualization algorithm module, and configured to receive the virtual image information in the form of the RGBW signal, and calculate an adjusted backlight brightness value of the backlight module according to image brightness information detected from the virtual image information in the form of the RGBW signal; and
an information adaption module connected with the brightness adjustment module and the virtualization algorithm module, and configured to receive the virtual image information in the form of the RGBW signal and concurrently receive the adjusted backlight brightness value calculated by the brightness adjustment module, perform adaption computing between the virtual image information in the form of the RGBW signal and the adjusted background brightness value to obtain image grayscale brightness information, and output the virtual image information in the form of the RGBW signal and carrying the image grayscale brightness information to the output interface unit.

13. The display panel according to claim 9, wherein the driving integrated unit comprises:
a signal conversion module connected with the input interface unit, and configured to convert the received original image information in the form of an RGB signal to image information in the form of an RGBW signal;
a brightness adjustment module connected with the signal conversion module, and configured to receive the image information in the form of the RGBW signal, and calculate an adjusted backlight brightness value of the backlight module according to image brightness information detected from the image information in the form of the RGBW signal;
an information adaption module connected with the brightness adjustment module and the signal conversion module, and configured to receive the image information in the form of the RGBW signal and concurrently receive the adjusted backlight brightness value calculated by the brightness adjustment module, perform adaption computing between the image information in the form of the RGBW signal and the adjusted background brightness value to obtain image grayscale brightness information; and
a virtualization algorithm module connected with the information adaption module, and configured to receive the image information in the form of the RGBW signal and carrying the image grayscale brightness information, perform virtual-rendering processing on the image information in the form of the RGBW signal to obtain virtual image information in the form of the RGBW signal and carrying the image grayscale brightness information.

14. The display panel according to claim 9, wherein the driving integrated unit comprises:
a virtualization algorithm module connected with the input interface unit, and configured to perform virtual rendering processing on the received original image information in the form of a RGB signal, to obtain virtual image information in the form of the RGB signal;
a brightness adjustment module connected with the virtualization algorithm module, and configured to receive the virtual image information in the form of the RGB signal, and calculate an adjusted backlight brightness value of the backlight module according to image brightness information detected from the virtual image information in the form of the RGB signal;
an information adaption module connected with the brightness adjustment module and the virtualization algorithm module, and configured to receive the virtual image information in the form of the RGB signal and concurrently receive the adjusted backlight brightness value calculated by the brightness adjustment module, perform adaption computing between the virtual image information in the form of the RGB signal and the adjusted background brightness value to obtain image grayscale brightness information; and
a signal conversion module connected with the information adaption module, and configured to convert the received virtual image information in the form of the RGB signal and carrying the image grayscale brightness information to virtual image information in the form of an RGBW signal and carrying the image grayscale brightness information.

15. The display panel according to claim 9, wherein the driving integrated unit comprises:
a brightness adjustment module connected with the input interface unit, and configured to receive the original image information in the form of an RGB signal, and calculate an adjusted backlight brightness value of the backlight module according to image brightness information detected from the original image information in the form of the RGB signal;
an information adaption module connected with the brightness adjustment module and the input interface unit, and configured to receive the original image information in the form of the RGB signal and concurrently receive the adjusted backlight brightness value calculated by the brightness adjustment module, perform adaption computing between the original image information in the form of the RGB signal and the adjusted background brightness value to obtain image grayscale brightness information;
a signal conversion module connected with the information adaption module, and configured to convert the received original image information in the form of the RGB signal and carrying the image grayscale brightness information to image information in the form of the RGBW signal and carrying the image grayscale brightness information; and
a virtualization algorithm module connected with the signal conversion module, and configured to receive the image information in the form of the RGBW signal and carrying the image grayscale brightness information, perform virtual-rendering processing on the image information in the form of the RGBW signal to obtain virtual image information in the form of the RGBW signal and carrying the image grayscale brightness information.
